(19) United States
(12) Patent Application Publication
(10) Pub. No.: US 2013/0110544 A1
(43) Pub. Date: May 2, 2013

(54) MEDICAL DATA MANAGEMENT WITH DISCLOSURE TRACKING FEATURES

(71) Applicant: Benoit P. Menez, Carmel, IN (US)

(72) Inventor: Benoit P. Menez, Carmel, IN (US)

(73) Assignee: Roche Diagnostics Operations, Inc., Indianapolis, IN (US)

(21) Appl. No.: 13/286,484

(22) Filed: Nov. 1, 2011

(51) Int. Cl. G06Q 50/24

(52) U.S. Cl. 705/3

(57) ABSTRACT

A system for tracking disclosures of protected health information of a patient by a healthcare professional to an entity includes a disclosure module, a logging module, and an accounting module. The disclosure module provides a disclosure to the entity. The disclosure includes the protected health information of the patient stored in a database. The logging module generates a log related to the disclosure and stores the log in the database. The accounting module provides an accounting of the disclosure based on the log in response to receiving a request for the accounting from the healthcare professional.

### FIELD

The present disclosure relates generally to patient data management and more particularly to tracking and reporting disclosures of patient data.

### BACKGROUND

Physicians generally enter notes in charts after examining patients. The notes may relate to symptoms, diagnoses, and treatment of the patients. The charts may also include reports from sources such as laboratories, radiologists, hospitals, and/or other physicians that provide healthcare services to the patients. Additionally, in cases of patients suffering from diseases such as diabetes, the physicians and patients may use equipment to monitor and control the health of the patients. The physicians and patients may use software programs and the Internet to exchange data that may be generated and/or utilized by the equipment. For example, glucose readings taken by a patient's equipment may be transmitted to a physician, and based on the readings, the physician may change insulin dosage to be administered to the patient by the patient's equipment. These data, the physicians' notes, and the reports in the patients' charts constitute patients' health information.

Disclosure of patients' health information is generally regulated by laws (e.g., the Health Insurance Portability and Accountability Act (HIPAA)). Physicians can disclose the health information to third parties according to the laws. The laws may also entitle the patients to receive an accounting (a report) of the disclosures made over a predetermined period of time. For example, under the HIPAA, the patients can request an accounting of disclosures made over a period of six years prior to the date of request.

Currently, processes used by healthcare providers (e.g., the physicians) to prepare the accounting of disclosures are arduous. For example, the physicians have to dig through piles of papers; search the papers; locate the disclosures made from the papers; compile a list of disclosures including details such as kind of data disclosed, parties to whom the information was disclosed, dates on which the information was disclosed; and prepare an accounting of the disclosures from the compilation. Accordingly, there is a need for automating the accounting process.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A system for tracking disclosures of protected health information of a patient by a healthcare professional to an entity includes a disclosure module, a logging module, and an accounting module. The disclosure module provides a disclosure to the entity. The disclosure includes the protected health information of the patient stored in a database. The logging module generates a log related to the disclosure and stores the log in the database. The accounting module provides an accounting of the disclosure based on the log in response to receiving a request for the accounting from the healthcare professional.

A method for tracking disclosures of protected health information of a patient by a healthcare professional to an entity includes providing a disclosure to the entity, where the disclosure includes the protected health information of the patient stored in a database. The method further includes generating a log related to the disclosure, storing the log in the database, and providing an accounting of the disclosure based on the log in response to receiving a request for the accounting from the healthcare professional.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a healthcare system according to the present disclosure;

FIG. 2 is a functional block diagram of a disclosure tracking system according to the present disclosure;

FIG. 3 is a flowchart of a method for archiving health information according to the present disclosure;

FIG. 4 is a flowchart of a method for disclosing health information according to the present disclosure;

FIG. 5 is a flowchart of a method for generating an accounting of disclosures according to the present disclosure; and

FIG. 6 is a functional block diagram of a cloud-based disclosure tracking system according to the present disclosure.

### DETAILED DESCRIPTION

The present disclosure relates to systems and methods for tracking and reporting disclosures of protected health information of a patient by a healthcare professional to third parties. Specifically, a system according to the present disclosure automatically logs information about the disclosures in a database whenever the disclosures are made. The information logged includes information about the disclosures and not necessarily the information disclosed. For example, the information logged includes identities of the parties requesting and making the disclosures, the type of information disclosed, and the dates and times at which the disclosures are made. The system automates collection of disclosure information and allows the healthcare professional to easily retrieve past disclosure information when requested by a patient. The healthcare professional can produce a list of disclosures and filter the list by one or more criteria. For example, the criteria can include identities of requesting and/or disclosing parties and the patient.

More specifically, the logging of the disclosures is automated and transparent to the disclosing party (i.e., the healthcare professional). Automated and transparent logging of disclosures ensures that each disclosure is logged, that all the information about the disclosure that needs to be collected is in fact collected, and that the disclosure information is correct. The system provides centralized storage of the disclosure information and stores the disclosure information for an indefinite duration. Storing the disclosure information centrally and for indefinite duration ensures that the disclosure information is not lost. The system produces an accounting of disclosures at a simple request by the healthcare professional. Accordingly, the accounting is produced fast, contains only the data for a particular patient, and contains all the data that is complete and correct.

Throughout the present disclosure, the term “healthcare professional” includes, but is not limited to, health plans, healthcare clearinghouses, and healthcare providers. A health plan means an individual or group plan that provides, or pays the cost of, medical care. A healthcare clearinghouse means a public or private entity that provides billing services, re-pricing companies, community health management information systems and/or community health information systems, and so on. A healthcare provider means a provider of medical or other health services, and any other person or organization who furnishes, bills, or is paid for healthcare.

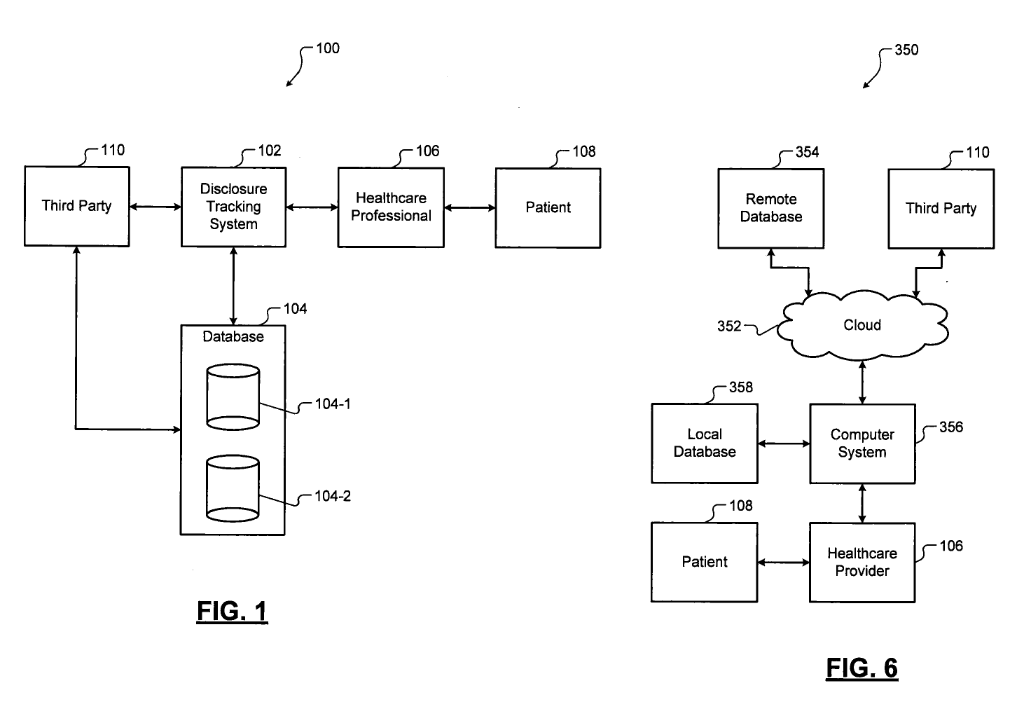

Referring now to FIG. 1, a healthcare system 100 according to the present disclosure is shown. The healthcare system 100 includes a disclosure tracking system 102, a database 104, a healthcare professional 106, a patient 108, and a third party 110. The disclosure tracking system 102 and/or the third party 110 may communicate with the database 104 via the Internet, for example. Although only one disclosure tracking system 102 and only one third party 110 are shown, the system 100 can include a plurality of disclosure tracking system 102 and a plurality of third party 110 that communicate with the database 104.

The database 104 may include a plurality of databases. For example, the database 104 may include a first database 104-1 to store patient's health information and a second database 104-2 to store a log of disclosure information. One or more of the plurality of databases may be local or remote relative to the disclosure tracking system 102 and/or the third party 110.

The disclosure tracking system 102 may include one or more computers. For example, the one or more computers of the disclosure tracking system 102 may be interconnected via a local area network (LAN) at the healthcare professional's office. The disclosure tracking system 102 may execute a software program that interfaces with one or more of the healthcare professional's and/or the patient's equipment (e.g., a blood glucose meter and/or an insulin pump). The healthcare professional 106 may examine the patient 108 and enter the patient's health information from the chart (including data gathered by the healthcare professional's and/or the patient's equipment) into the software program of the disclosure tracking system 102. The disclosure tracking system 102 uploads the patient's health information into the database 104 (e.g., into the first database 104-1).

The third party 110 may send a request to the disclosure tracking system 102 for the patient's health information. The disclosure tracking system 102 verifies that the third party's request complies with the laws of the jurisdiction and that the laws of the jurisdiction allow the third party 110 to make the request. If the third party's request complies with the laws of the jurisdiction, the disclosure tracking system 102 retrieves the patient's health information from the database 104. The disclosure tracking system 102 discloses the patient's health information to the third party 110 directly or via the database 104. The disclosure tracking system 102 generates a log of the disclosure information and stores the log in the database 104 (e.g., in the second database 104-2).

For each disclosure, the log may include identities of the healthcare professional 106 authorizing the disclosure, the disclosure tracking system 102 making the disclosure, and the third party 110 receiving the disclosure. Additionally, the log may include the type of information disclosed and date and time at which the disclosure was made. The log may include other types of data and information related to the disclosure.

The patient 108 may request an accounting of disclosures made over a period of time by the healthcare professional 106 to entities such as the third party 110. The disclosure tracking system 102 retrieves the log of the disclosures stored in the database 104. From the log, the disclosure tracking system 102 generates a list of the disclosures made over the period of time to entities such as the third party 110. The disclosure tracking system 102 would filter the log based on the identities of the patient 108 and/or the third party 110. From the list, the disclosure tracking system 102 generates an accounting (i.e., a report) of disclosures made by the healthcare professional 106 to entities such as the third party 110.

Referring now to FIG. 2, the disclosure tracking system 102 is shown in detail. The disclosure tracking system 102 includes an interface module 150, a collection module 152, a formatting module 154, an archiving module 156, a security module 158, a disclosure module 160, a logging module 162, and an accounting module 164. The disclosure tracking system 102 tracks the disclosures of health information of the patient 108 made by the healthcare professional 106 to entities such as the third party 110 as described below.

The interface module 150 provides the healthcare professional 106 with a graphical user interface (GUI). As explained below, the healthcare professional 106 can use the GUI to enter the health information into the disclosure tracking system 102, make disclosures, and generate an accounting of the disclosures.

The collection module 152 collects the health information of the patient 108 entered by the healthcare professional 106. The health information may be received from one or more sources providing a healthcare service to the patient 108 including the healthcare professional 106, a laboratory, a hospital, and/or another healthcare professional. The healthcare professional 106 may enter the health information using one or more input devices including a keyboard, a microphone, a dictation apparatus, and/or a scanner. Additionally, the disclosure tracking system 102 may automatically (e.g., electronically) receive health information from sources such as a laboratory, a hospital, and so on, and may automatically (e.g., electronically) upload the health information into the database 104 without intervention from the healthcare professional 106.

The formatting module 154 formats the health information into a format that allows the health information to be searched in the database 104. For example, the formatting module 154 may tag portions of the health information based on type of data included in the health information. The health information can then be searched in the database 104 using the tags. The archiving module 156 stores the formatted health information in the database 104.

The disclosure tracking system 102 may receive a request for disclosure from the third party 110. The healthcare professional 106 may enter the request via the interface module 150. The security module 158 determines, prior to providing the disclosure to the third party 110, whether the third party 110 is authorized to receive the disclosure according to the laws of the jurisdiction to receive the disclosure. For example, if an entity such as a credit reporting agency requests disclosure of a patient's health information, the security module 158 will deny the request.

The healthcare professional 106 may use the GUI to make the disclosure. For example, the GUI may provide a drop-down menu. The drop-down menu may allow the healthcare professional 106 to select a type of disclosure (e.g., type A, B, C, and so on; or alternatively, type 1, 2, 3, and so on). For example, a type 1 disclosure may be a disclosure made to an insurance company that is trying to determine insurability of the patient 108; a type 2 disclosure may be a disclosure made to another healthcare provider (e.g., a physician that the patient 108 may consult for a second opinion); and so on.

Alternatively, the drop-down menu may provide predetermined codes that indicate the types of disclosures recognized in the industry according to laws of the jurisdiction. For example, a code may classify a disclosure as a NN(x) disclosure, where NN(x) may be an alphanumeric code corresponding to a subsection of a law that authorizes the NN(x) disclosure. For example, hypothetically, a subsection 99(b) of United States Code 100 may authorize disclosure of types of data about patients to a government agency such as the Centers for Disease Control and Prevention (CDC) or the Food and Drug Administration (FDA) of the U.S. government.

Other identifiers to identify, standardize, and simplify the disclosures may be used. Additionally, the drop-down menu may provide a custom option, where the healthcare professional 106 can custom-select the health information to be disclosed. The formatting module 154 may format the health information using tags that correspond to, or that are derived from, the disclosure types/codes. The tags may facilitate searching and locating the health information at the time of disclosure.

The archiving module 156 retrieves the health information from the database 104 based on the disclosure type selected by the healthcare professional 106. The disclosure module 160 discloses the health information to the third party 110. The disclosure may be made in electronic and/or paper form. For example, the disclosure may be made electronically by sending an email or uploading a file to a system of the third party 110. The disclosure may be made electronically by copying the health information on a disc or a flash drive and mailing the disc or the flash disk to the third party 110. The disclosure may also be made by printing the health information and mailing the printed health information to the third party 110.

The logging module 162 generates a log of the disclosure. The archiving module 156 stores the log in the database 104. The log includes identifications of the patient 108, the healthcare professional 106, and the third party 110. The log also includes the type of data included in the disclosure. For example, the log may flag or mark the disclosure as a type A, B, or C disclosure based on the type of data disclosed. Alternatively, the log may mark the disclosure based on the code (e.g., NN(x)) selected from the drop-down menu by the healthcare professional 106. The log may also include information about the medium (e.g., electronic and/or paper) used to make the disclosure. The log also includes the date and time when the disclosure was made.

The database 104 stores the log for a period of time that is more than a minimum amount of time mandated by law (e.g., six years under HIPAA). Storing the log for at least the minimum amount of time ensures that patients can receive an accounting of disclosures made during at least the minimum amount of time mandated by law.

The accounting module 164 provides an accounting of the disclosures, when requested by the patient 108, based on the log of the disclosures stored in the database 104. The healthcare professional 106 uses the GUI to initiate the accounting. For example, the healthcare professional 106 uses the GUI to enter a request to retrieve from the database 104 a list of all the disclosures made during a predetermined time period. The healthcare professional 106 may also input the patient's identity to limit the search.

The archiving module 156 searches the log of disclosures in the database 104 and retrieves a list of the disclosures made during the predetermined time period. The accounting module 164 sorts the list and generates a report based on the log. The report includes the following information for each disclosure: the identities of the patient 108, the healthcare professional 106, and entities such as the third party 110; the type of data included in the disclosure (e.g., if the disclosure was of type A, B, or C); and the date and time when the disclosure was made.

The accounting module 164 filters the log based on the type of disclosure. The accounting module 164 may exclude from the accounting one or more disclosures provided by the healthcare professional 106 that are exempt from reporting according to law. For example, the accounting module 164 may exclude the disclosures provided by the healthcare professional 106 for the purpose of payment, treatment, and operation (PTO).

The healthcare professional 106 can provide the report of the accounting to the patient 108 in many ways. For example, the report can be printed and mailed to the patient 108. The report can also be emailed to the patient 108. Thus, using the disclosure tracking system 102, the healthcare professional 106 does not have to dig through piles of paper and manually compile the report.

In some implementations, the disclosure tracking system 102 may process disclosure requests automatically without intervention by the healthcare professional 106. For example, the security module 158 may receive a disclosure request from the third party 110. The security module 158 may determine whether the third party is authorized to receive the requested information. The disclosure module 160 may automatically parse the disclosure request and determine the type of disclosure to be made. The archiving module 156 may retrieve the health information from the database 104 based on the type of disclosure. The disclosure module 160 may disclose the health information to the third party 110 in an electronic form. The logging module 162 generates a log of the disclosure. The archiving module 156 stores the log in the database 104.

Alternatively, the disclosure module 160 may provide an authorization code to the third party 110 to obtain the health information directly from the database 104. The authorization code may include identities of the healthcare professional 106, the third party 110, and the patient 108. The authorization code may also include the type of disclosure the third party 110 is authorized to receive. The third party 110 may use the authorization code to directly access the database 104 and obtain from the database 104 the health information authorized by the authorization code. Based on the authorization code and the type of disclosure, the database 104 may generate a log of the disclosure.

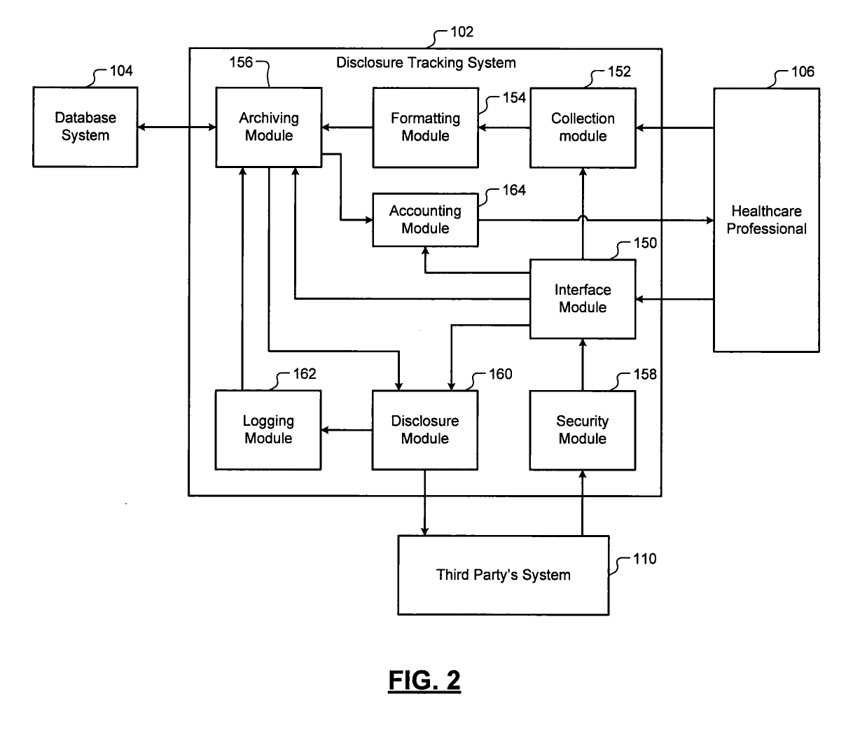

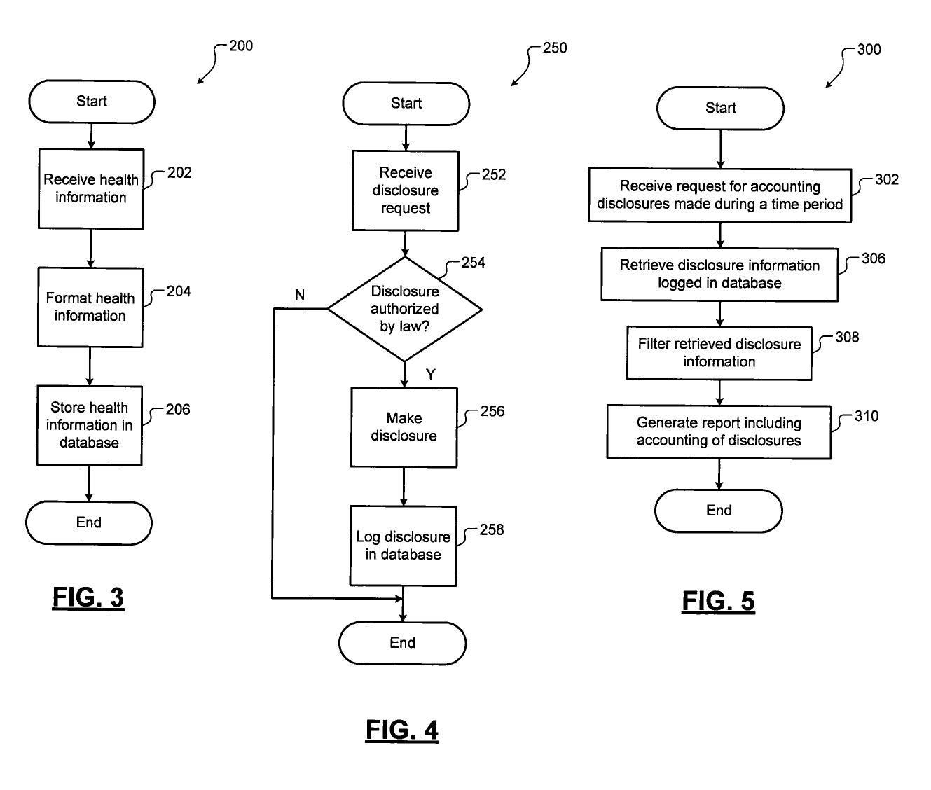

Referring now to FIGS. 3-5, methods for archiving, disclosing, and accounting health information are shown. In FIG. 3, a method 200 for archiving health information is shown. Control receives health information of a patient entered by a healthcare professional at 202. Control formats the health care information at 204. Control stores the formatted health information in a database at 206.

In FIG. 4, a method 250 for disclosing health information is shown. Control receives a disclosure request from a third party at 252. At 254, control determines whether the disclosure to the third party is authorized by the laws of the jurisdiction. Additionally, control determines whether the disclosure to the third party is known to, and authorized by, the healthcare professional 106. At 256, if the disclosure is authorized by law, control makes the disclosure to the third party. At 258, control logs information about the disclosure in the database.

In FIG. 5, a method 300 for generating an accounting of disclosures is shown. At 302, control receives a request to generate an accounting of disclosures made during a time period. At 306, control retrieves disclosure information logged in the database. At 308, control filters the retrieved disclosure information (e.g., for non-accountable disclosures such as PTO disclosures, or based on the patient's identity). At 310, control generates a report that includes an accounting of the disclosures made during the requested time period.

Referring now to FIG. 6, a cloud-based disclosure tracking system 350 is shown. In the system 350, an application implemented in a cloud 352 receives patients' health information from various healthcare service providers, makes disclosures to various third parties, logs the disclosures, and generates an accounting of the disclosures. A central database 354 stores the patients' health information and logs of the disclosures made to the third parties. For example, the database 354 may include a first database 354-1 to store the patients' health information and a second database 354-2 to store the logs of disclosure information.

Although only one healthcare professional 106, only one patient 108, and only one third party 110 are shown, the system 350 can include a plurality of healthcare professional 106, a plurality of patient 108, and a plurality of third party 110. Further, the plurality of healthcare professional 106, the plurality of patient 108, the plurality of third party 110, and the remote database 354 may be located in different countries or legal jurisdictions. The central database 354, the healthcare professional 106, and the third party 110 may communicate with the cloud 352 via the Internet.

The healthcare professional 106 uses a computer system 356 that may include one or more computers interconnected via a local area network (LAN) at the healthcare professional's office. The computer system 356 may execute a software program that interfaces with one or more of the healthcare professional's and/or the patient's equipment (e.g., a blood glucose meter and/or an insulin pump). The healthcare professional 106 may examine the patient 108 and enter the patient's health information from the chart (including data gathered by the healthcare professional's and/or the patient's equipment) into the software program. The computer system 356 uploads the patient's health information into the remote database 354 (e.g., into the first database 354-1). The computer system 356 may optionally have a local database 358. The computer system 356 may store the patient's health information into the local database 358 and may upload the patient's health information from the local database 358 to the remote database 354 on a scheduled basis.

The third party 110 may send a request for the patient's health information to the application or to the healthcare professional 106 via the application. The application verifies that the third party 110 is authorized to receive the requested information according to the laws of the jurisdictions in which the patient 108 and the third party 110 are located. The application (or using the application, the healthcare professional 106) retrieves the patient's health information from the remote database 354 and discloses the patient's health information to the third party 110 in ways explained above. In some instances, the healthcare professional 106 may also disclose the patient's health information on his/her own initiative. The application generates a log of the disclosure and stores the log in the remote database 354 (e.g., in the second database 354-2).

When the patient 108 requests an accounting of disclosures made over a period of time by the healthcare professional 106 to entities such as the third party 110, the healthcare professional 106 uses the application to retrieve the log of the disclosures stored in the database 354 and to generate an accounting (i.e., a report) listing the disclosures made over the period of time as explained above.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

What is claimed is:

1. A system for tracking disclosures of protected health information of a patient by a healthcare professional to an entity, the system comprising:
a disclosure module that provides a disclosure to the entity, wherein the disclosure includes the protected health information of the patient stored in a database;
a logging module that generates a log related to the disclosure and that stores the log in the database; and
an accounting module that provides an accounting of the disclosure based on the log in response to receiving a request for the accounting from the healthcare professional.

2. The system of claim 1, wherein the logging module marks the disclosure with an identifier when the log related to the disclosure is generated and stored in the database, wherein the identifier identifies the disclosure by a type of data included in the disclosure, and wherein the accounting module locates the disclosure in the log based on the identifier.

3. The system of claim 1, wherein the log includes at least one of (i) identifications of the patient, the healthcare professional, and the entity; (ii) types of data included in the disclosure; (iii) a medium via which the data are disclosed to the entity; and (iv) date and time when the disclosure is provided to the entity.

4. The system of claim 1, wherein the accounting module generates a report including a list of the disclosures, and wherein the report includes, for each of the disclosures, at least one of (i) identifications of the patient, the healthcare professional, and the entity; (ii) types of data included in the disclosure; and (iii) date and time when the disclosure was provided to the entity.

5. The system of claim 1, wherein the accounting module filters the log and excludes from the accounting one or more of the disclosures provided by the healthcare professional that are exempt from reporting according to law.

6. The system of claim 1, wherein the logging module stores the log in the database for a period of time that is at least a minimum amount of time mandated by law.

7. The system of claim 1, further comprising a security module that determines, prior to providing the disclosure to the entity, whether the entity is authorized to receive the disclosure.

8. The system of claim 1, further comprising a collection module that collects the protected health information from a source providing a healthcare service to the patient and that stores the protected health information in the database, wherein the source includes at least one of the patient, the healthcare professional, a laboratory, and a hospital.

9. A method for tracking disclosures of protected health information of a patient by a healthcare professional to an entity, the method comprising:
providing a disclosure to the entity, wherein the disclosure includes the protected health information of the patient stored in a database;
generating a log related to the disclosure;
storing the log in the database; and
providing an accounting of the disclosure based on the log in response to receiving a request for the accounting from the healthcare professional.

10. The method of claim 9, further comprising:
marking the disclosure with an identifier when the log related to the disclosure is generated and stored in the database, wherein the identifier identifies the disclosure by a type of data included in the disclosure; and
locating the disclosure in the log based on the identifier when providing the accounting of the disclosure.

11. The method of claim 9, wherein the log includes at least one of (i) identifications of the patient, the healthcare professional, and the entity; (ii) types of data included in the disclosure; (iii) a medium via which the data are disclosed to the entity; and (iv) date and time when the disclosure is provided to the entity.

12. The method of claim 9, further comprising generating a report including a list of the disclosures, and wherein the report includes, for each of the disclosures, at least one of (i) identifications of the patient, the healthcare professional, and the entity; (ii) types of data included in the disclosure; and (iii) date and time when the disclosure was provided to the entity.

13. The method of claim 9, further comprising filtering the log and excluding from the accounting one or more of the disclosures provided by the healthcare professional that are exempt from reporting according to law.

14. The method of claim 9, further comprising storing the log in the database for a period of time that is at least a minimum amount of time mandated by law.

15. The method of claim 9, further comprising determining, prior to providing the disclosure to the entity, whether the entity is authorized to receive the disclosure.

16. The method of claim 9, further comprising:
collecting the protected health information from a source providing a healthcare service to the patient; and
storing the protected health information in the database,
wherein the source includes at least one of the patient, the healthcare professional, a laboratory, and a hospital.

17. A system for tracking disclosures of protected health information of patients by healthcare professionals to entities, the system comprising:
a collection module that collects the protected health information of the patients from sources providing healthcare services to the patients and that stores the protected health information in a database, wherein the sources include the patients, healthcare professionals, laboratories, and hospitals;
a disclosure module that provides the disclosures to the entities after verifying that the entities are authorized to receive the disclosures, wherein the disclosures include the protected health information of the patients stored in the database;
a logging module that generates a log related to the disclosures and that stores the log in the database, wherein the log includes at least one of (i) identifications of the patients, the healthcare professionals, and the entities; (ii) types of data included in the disclosures; (iii) media via which the data are disclosed to the entities; and (iv) dates and times when the disclosures are provided to the entities; and
an accounting module that provides an accounting of the disclosures based on the log in response to receiving a request for the accounting from one of the healthcare professionals and that generates a report including a list of the disclosures provided by the one of the healthcare professionals for one of the patients, wherein the report includes, for each of the disclosures, at least one of (i) identifications of the one of the patients, the one of the healthcare professionals, and the entities; (ii) types of data included in the disclosures; and (iii) date and time when the disclosures were provided to the entities.

18. The system of claim 17, wherein the logging module marks the disclosures with identifiers when the log related to the disclosures is generated and stored in the database, wherein the identifiers identify the disclosures by types of data included in the disclosures, and wherein the accounting module locates the disclosures in the log based on the identifiers.
